(19) United States
(12) Patent Application Publication
(10) Pub. No.: US 2024/0218915 A1
(43) Pub. Date: Jul. 4, 2024

(54) ENERGY CHAIN WITH A DRIVE UNIT, AND SYSTEM CONSISTING OF AN ENERGY CHAIN WITH A DRIVE UNIT AND A STORAGE UNIT

(71) Applicant: IGUS GMBH, Koeln (DE)

(72) Inventors: Bilal YILMAZ, Koeln (DE); Simon MORITZ, Koeln (DE); Andreas HERMEY, Hennef (DE)

(21) Appl. No.: 18/558,569

(22) PCT Filed: May 3, 2022
(86) PCT No.: PCT/EP2022/061821

§ 371 Date: Nov. 2, 2023

(30) Foreign Application Priority Data
May 3, 2021 (DE) 20 2021 102 371.6

(51) Int. Cl. F16G 13/16; H02G 11/00

(52) U.S. Cl. CPC F16G 13/16; H02G 11/006

(57) ABSTRACT

An energy chain with a drive unit. The energy chain has chain links that adjoin one another in the longitudinal direction of the energy chain and can be pivoted relative to one another, each chain link comprising two lateral parts, which lie opposite each other in a direction transverse to the longitudinal direction, and crosspieces, which connect the lateral parts together. The drive unit has a drivable drive roller with radial protrusions that engage between the crosspieces. The crosspieces have regions which are reinforced in the connection regions adjoining the lateral parts of the chain links and in which the strength of the crosspieces is reinforced, and the drive roller is arranged and designed such that the radial protrusions of the drive roller engage between the regions of reinforced strength. A system consisting of an energy chain with a drive unit of the aforementioned type and a storage unit for the energy chain.

### FIELD

The invention relates to an energy chain, for receiving and guiding power and information transmission lines between a fixed connector region and a movable one, with a drive unit, wherein the energy chain has chain links that adjoin one another in their longitudinal direction, are pivotable relative to one another and each comprise two lateral parts that lie opposite one another in a first direction transverse to the longitudinal direction and crosspieces connecting them to one another, wherein the drive unit has a drivable drive roller, which has radial protrusions that are distributed at equal distances over its circumferential region and engage between the crosspieces.

The invention furthermore relates to a system consisting of an energy chain with a drive unit of the type mentioned above and a storage unit for the energy chain.

### BACKGROUND

Drive units of the type mentioned above that cooperate with energy chains are known from the state of the art. In particular in the case of longer and heavier energy chains, they serve to drive or to support the driving of the energy chain. However, the possible uses of such known drive units are limited due to the sometimes high forces from the radial protrusions of the drive roller acting on the cross bars. This applies in particular to applications in which a longer region of an energy chain is to be retracted into a storage housing and wound up therein.

### SUMMARY

The object of the invention is to broaden the possible uses of an energy chain with a drive unit of the type mentioned above in particular in relation to the moving of longer and heavier energy chains as well as the introduction of an energy chain into a storage housing, in which the chain winds itself up.

The object is achieved according to the invention, wherein an energy chain with a drive unit of the type mentioned at the beginning, it is provided that the crosspieces have, in their connecting regions adjacent to the lateral parts of the chain links, regions in which their strength is reinforced compared with the portions of the crosspieces lying between these regions, and the drive roller of the drive unit is arranged and formed relative to the energy chain such that the radial protrusions engage between the regions with reinforced strength of the crosspieces.

The crosspieces, between which the radial protrusions of the drive roller engage, can be arranged in the region of a side of the energy chain facing in a second transverse direction, which runs perpendicular to the first transverse direction and the longitudinal direction of the energy chain. The crosspieces having the regions with reinforced strength are thus arranged on the side of the energy chain facing towards the drive roller. In the region of the side of the energy chain lying opposite this side, the lateral parts can also be connected to one another by further crosspieces which have no regions with reinforced strength in the regions connecting to the lateral parts. In the case of an arrangement of the energy chain in space in which the second transverse direction extends vertically, upper and lower crosspieces are involved. The radial protrusions of the drive roller then cooperate with the upper or lower crosspieces, depending on their arrangement above or below the energy chain.

As a result of the solution according to the invention, the crosspieces of the chain links can be formed, in the portions between their end regions with reinforced strength, in their usual design, which merely guarantees the stability of the chain links, and provide an unrestricted receiving space for the lines inside the energy chain in the region of the portions. For their part, the end regions with reinforced strength of the crosspieces enable higher forces to be absorbed when these regions are loaded by the radial protrusions of the drive roller for transporting the chain.

A single drive roller cooperating with the energy chain can be sufficient even in the case of longer and heavier energy chains and the applications mentioned above.

In particular, it can be provided that the regions with reinforced strength of the crosspieces have a material reinforcement compared with the portions of the crosspieces lying in between.

The material reinforcement can consist of the regions with reinforced strength having a greater width in the longitudinal direction of the energy chain and/or a greater height directed perpendicular to the longitudinal direction and parallel to the lateral parts. In addition or alternatively, reinforcing inserts in the regions in question also come into consideration. The regions in question can also consist of a material with a higher strength than the material in the portions of the crosspieces lying in between.

The geometry of the spaces between the regions with reinforced strength, which, in the case of adjoining chain links are arranged neighbouring one another in the longitudinal direction of the energy chain, can correspond to the geometry of the protrusions arranged on the drive roller.

In particular, the spaces can be formed trapezoidal with a width increasing towards the drive roller in the longitudinal direction of the chain. Such a geometry of the spaces and the geometry of the protrusions corresponding to this geometry enable a sliding and low-friction engagement of the radial protrusions of the drive roller in the spaces between the regions with reinforced strength of the crosspieces neighbouring one another in the longitudinal direction of the chain.

The portions of the crosspieces extending between the regions with reinforced strength can be formed as separate, bar-like parts, which can be connected or are connected to the adjacent regions with reinforced strength. In particular, in this design of the crosspieces, usual cross bars being used in energy chains, also without a drive roller, can be inserted between the regions with reinforced strength to form the crosspieces.

The bar-like parts can be detachably connectable or connected to the regions with reinforced strength. This enables the crosspieces to be opened for the easy placing of lines in the chain and removal of lines from the chain. The bar-like parts and regions with reinforced strength can be connectable or connected to one another e.g. by catch means on the end faces of the bar-like parts and at the free ends of the regions with reinforced strength. Alternatively or in addition, a swivel connection for the bar-like parts can be provided at the free end of at least one of the two regions with reinforced strength lying opposite one another.

The regions with reinforced strength are preferably directly adjacent to the lateral parts neighbouring them.

In an embodiment, the regions with reinforced strength can be moulded in one piece on the lateral parts neighbouring them.

In an alternative embodiment, the regions with reinforced strength can be detachably connectable or connected to the lateral parts neighbouring them by fastening means. In this case, the regions with reinforced strength are formed as separate component parts, which can be screwed to the lateral parts e.g. by screws fed through the lateral parts from the outside.

The drive roller of the drive unit can have two circular disc-shaped parts that are arranged on its end faces. The two circular disc-shaped parts are connected to one another in a rotationally fixed manner and each have the radial protrusions. Here, the protrusions of one circular disc-shaped part cooperate with the regions with reinforced strength that neighbour one another in the longitudinal direction of the energy chain on one side thereof, while the radial protrusions of the other circular disc-shaped part cooperate with the regions with reinforced strength that neighbour one another in the longitudinal direction of the energy chain on the other side thereof.

The two circular disc-shaped parts can be connectable or connected to one another by a shaft, on which they are arranged in a rotationally fixed manner, in particular in each case via a hub.

The drive roller can have, on at least one of its outwardly facing end faces, an annular flange extending radially beyond the protrusions and overhanging the lateral parts of the chain links on the side in question. Preferably, both outwardly facing end faces of the drive roller have such an annular flange in each case. If two circular disc-shaped parts, as described above, are provided for the drive roller they have such an annular flange on their respectively outwardly facing end face. The two annular flanges on the outwardly facing end faces of the drive roller stabilize the position of the drive roller with a little play in relation to the chain links of the energy chain loaded by them in the case of forces acting transversely to the longitudinal direction of the chain.

The drive unit can have, on the side of the energy chain lying opposite the drive roller, at least one rotatably mounted roller, which causes the chain links cooperating with the drive roller to rest against the drive roller and to remain held in engagement with it. The axis of the roller is arranged parallel to the axis of the drive roller, with the result that the chain links of the energy chain cooperating with the drive roller can roll on the roller with a little play. have cooperating component parts.

Preferably, two guide rollers lying opposite one another in the transverse direction are provided, on which the laterally opposite lateral parts of the chain links can roll. For this, the lateral parts of the chain links can have narrow sides extending perpendicular to their lateral surfaces and in the longitudinal direction of the energy chain which, together with the narrow sides of lateral parts that neighbour one another in the longitudinal direction of the chain, form a largely continuous rolling surface.

The drive roller can be rotatably mounted on or in a housing of the drive unit, wherein one or both rollers can be arranged rotatably mounted on or in the housing on the side of the energy chain lying opposite the drive roller. The mounting of the at least one roller on or in the housing can have a little play in the direction of the axis of rotation of the drive roller to compensate for smaller tolerance deviations of the cooperating component parts of the drive unit.

The housing of the drive unit can have two legs arranged laterally outside the energy chain, between which the drive roller and the at least one guide roller are rotatably mounted.

A gear mechanism operatively connected to the drive roller in drive terms can be arranged on one side of the housing.

For the system belonging to the invention, consisting of an energy chain and a drive unit with the features described above and of a storage unit for the energy chain, it is provided that at least one portion of the energy chain can be wound up in the storage unit in the form of a spiral, wherein the spiral-shaped winding can have two winding shafts arranged at a distance from one another, the fixed connector region of the energy chain is arranged stationary inside the spiral-shaped winding and the movable connector region is arranged on a run of the energy chain extending through an opening in the storage housing, wherein the drive unit cooperates with the run of the energy chain extending out of the storage housing through the opening.

When the run of the energy chain adjoining the movable connector region is moved into the storage unit, the distance of the winding shafts from one another is changed from a minimum distance to a maximum distance, whereas when the run is moved out of the storage unit, the distance of the winding shafts from one another is changed from their maximum distance to their minimum distance.

According to a preferred design, no device which brings about a change in the distance between the two winding shafts 22 and 33 and contributes to the winding up and/or unwinding of the energy chain 1 in a force-exerting manner is provided between them. The change in the distance between the winding shafts is effected exclusively by the driving force acting on the run running outside the storage unit.

The storage housing and/or the deflection regions of the energy chain around the winding shafts can have guide elements that are movable parallel to the line connecting the two winding shafts, with or on which guide elements the deflection regions of the energy chain can be guided in a sliding manner during the retraction and winding up as well as during the extension and unwinding and which in the process follow the respective change in the distance between the two winding shafts.

The guide elements can be formed as semicircular channels arranged concentrically around the winding shafts, in which the deflection regions of the energy chain are guided in a sliding manner and which can be arranged in link-like component parts. At least one of these component parts is arranged movable parallel to the line connecting the winding shafts in order to enable the change in distance between the winding shafts.

In another embodiment, the guide elements can be formed as parts, such as e.g. curved bars, which are arranged floating within the deflection regions of the energy chain and stabilize the deflection curves radially inwardly as well as outwardly.

The storage housing can have lateral regions, which are parallel to the deflection regions and have guide means for supporting and guiding the runs of the energy chain extending between the deflection regions.

The housing of the drive unit can be fastened to the storage housing, e.g. with tab-shaped regions of the legs extending in the longitudinal direction of the energy chain, in the region of the opening of the storage housing through which the run of the energy chain adjoining the movable connector region extends outwards. However, the drive unit can also be arranged in the region of the run of the energy chain extending out of the opening without a fixed connection to the storage housing.

### BRIEF DESCRIPTION OF THE DRAWINGS

Embodiment examples of the energy chain according to the invention with a drive unit and a storage unit provided with the drive unit are described in more detail below with reference to the drawings. In the drawings:

FIG. 1 shows a perspective view of a first embodiment example, which shows two adjoining chain links of an energy chain and a drive unit cooperating with them;

FIG. 2 shows an exploded representation of the component parts of the chain links and drive unit shown in FIG. 1;

FIG. 3 shows a top view from above onto the chain links and drive unit shown in FIG. 1;

FIG. 4 shows a longitudinal section along the line A-A in FIG. 3;

FIG. 5 shows a perspective view of a second embodiment example, which shows two adjoining chain links of an energy chain and a drive unit cooperating with them;

FIG. 6 shows an exploded representation of the component parts of the chain links and drive unit shown in FIG. 5;

FIG. 7 shows a top view from above onto the chain links and drive unit shown in FIG. 5;

FIG. 8 shows a longitudinal section along the line B-B in FIG. 7;

FIG. 9 shows a perspective view of a drive unit arranged in a housing;

FIG. 10 shows an end face view of the drive unit, arranged in a housing, shown in FIG. 9;

FIG. 11 shows a side view of a drive unit connected to a storage unit;

FIG. 12 shows a top view from above onto the system shown in FIG. 11;

FIG. 13 shows a longitudinal section along the line C-C in FIG. 12;

FIG. 14 shows a perspective view of the system shown in FIG. 11;

FIG. 15 shows an enlarged view of the region D in FIG. 14;

FIG. 16 shows a perspective representation of the system shown in FIG. 14 with lateral component parts removed, partially in section; and

FIG. 17 shows an enlarged view of the region labelled E in FIG. 16.

### DETAILED DESCRIPTION

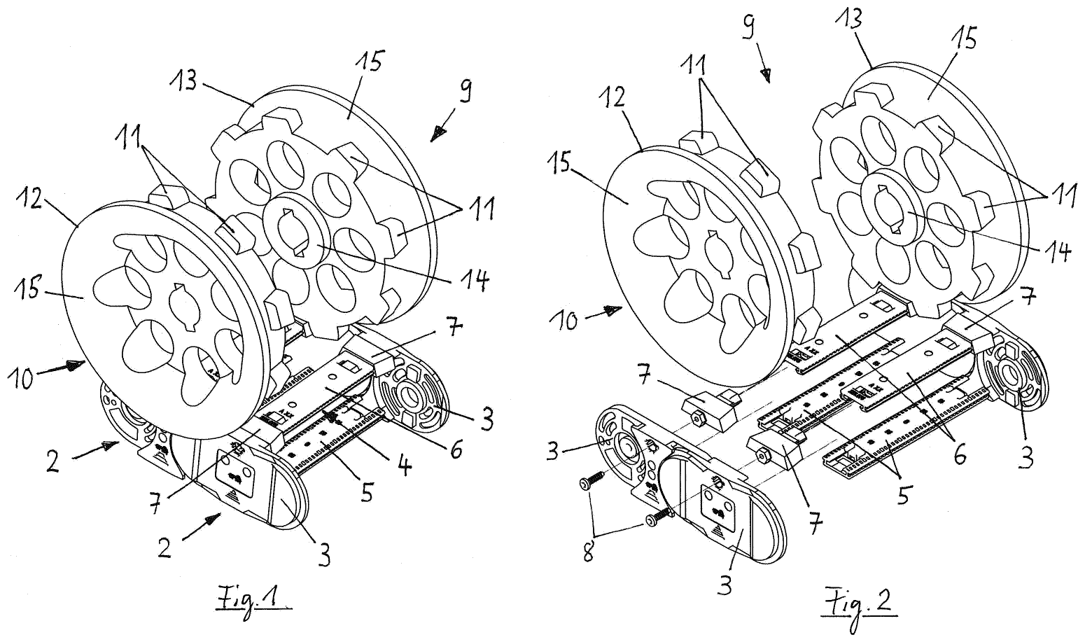

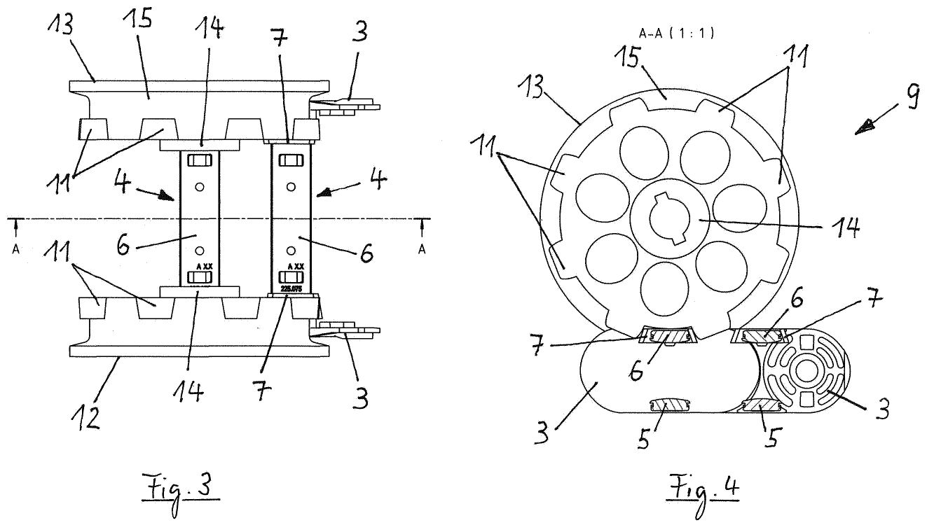

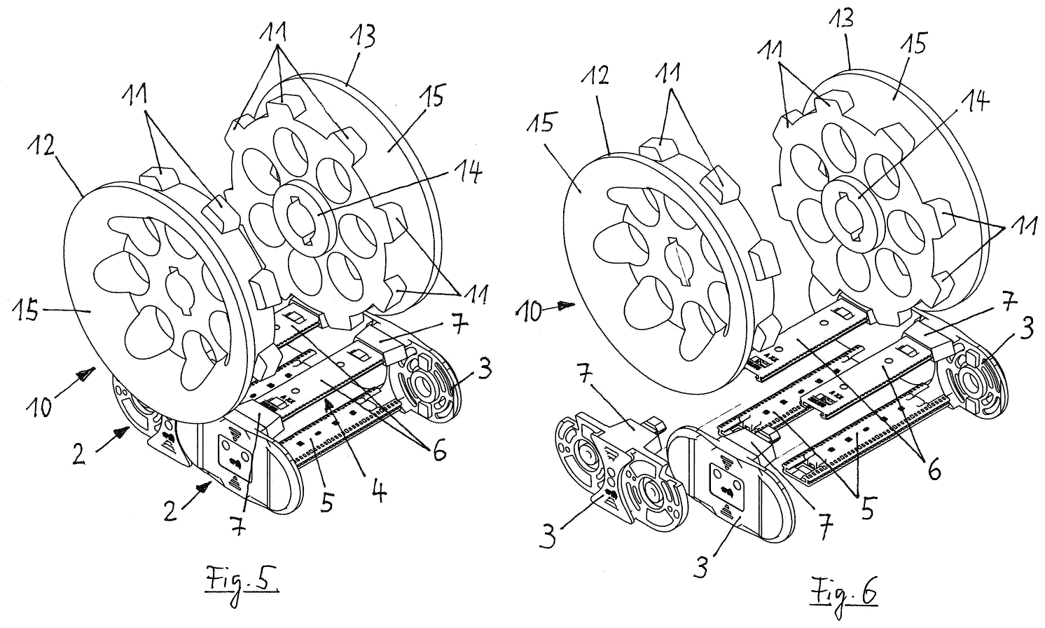

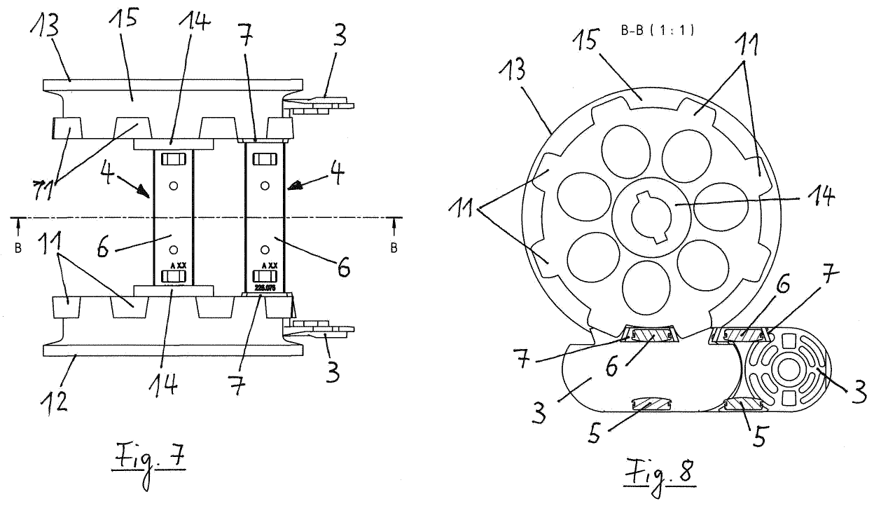

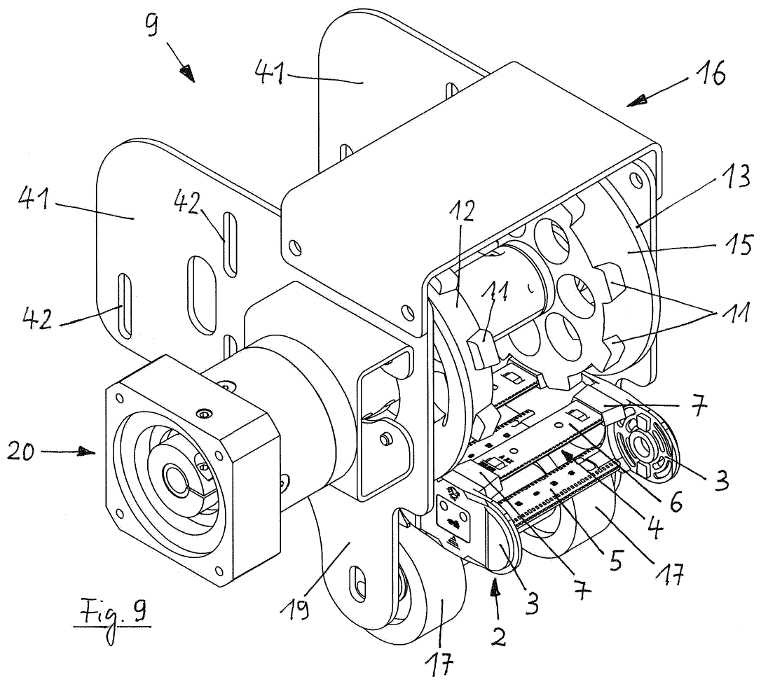

Two chain links 2 of an energy chain 1 adjoining one another in their longitudinal direction are represented in FIGS. 1 to 8. The chain links 2 that are pivotable relative to one another about an axis running in the direction transverse to their longitudinal direction each have two lateral parts 3 lying opposite one another in the transverse direction and crosspieces connecting the two lateral parts to one another, an upper crosspiece 4 and a lower crosspiece 5.

The upper crosspieces 4 are formed of conventional cross bars 6 guaranteeing the stability of the chain links and regions 7 with reinforced strength, between which the cross bars 6 are arranged. The connecting means used to connect the cross bars 6 to the regions 7 are likewise designed like conventional connecting means between cross bars 6 and lateral parts 3 of usual chain links of an energy chain. In the embodiment examples considered, they consist of catch means with which the upper cross bars 6 can be locked together with the regions 7 with reinforced strength from the outside, i.e. from above in the view of FIGS. 1, 2, 4, 5, 6 and 8.

The regions 7 with reinforced strength form a material reinforcement compared with the portions of the upper crosspieces formed as usual cross bars and lying in between, which material reinforcement consists of the fact that they have a greater width with respect to the longitudinal direction of the energy chain 1 and a greater height with respect to the direction perpendicular to the longitudinal direction and parallel to the lateral parts 3 compared with the cross bars 6. In each case, the regions 7 are formed in the shape of a clamp.

In the first embodiment example represented in FIGS. 1 to 4, the respective clamp is detachably connected to the respectively neighbouring lateral part 3 by fastening means, such as e.g. by the screw 8 represented in FIG. 2, whereas in the second embodiment example shown in FIGS. 5 to 8, the region 7 with reinforced strength formed as a clamp is moulded in one piece on the neighbouring lateral part 3.

As can be seen from FIGS. 1 to 8, the lateral parts 3 of the chain links 2 that neighbour one another in the longitudinal direction of the energy chain 1 consist of alternate inner and outer tabs. In place of inner and outer tabs, the energy chain 1 provided with the respective crosspieces of the two embodiment examples can also have cranked lateral parts.

As follows from FIGS. 1 to 4 and 5 to 8 of the two embodiment examples, the drive unit 9 cooperating with the chain links 2 of the energy chain 1 includes a drive roller 10, which has radial protrusions 11 distributed at equal distances over its circumferential region. The protrusions 11 are formed to engage in the spaces between the regions 7 with reinforced strength that neighbour one another in the longitudinal direction of the energy chain 1. The drive roller 10 has two circular disc-shaped parts 12 and 13, which are spaced apart from one another axially, can be connected to one another in a rotationally fixed manner and on which the radial protrusions 11 are arranged. Here, the protrusions 11 of one circular disc-shaped part 12 cooperate with the regions 7 with reinforced strength that neighbour one another in the longitudinal direction of the energy chain 1 on one side thereof, while the radial protrusions 11 of the other circular disc-shaped part 13 cooperate with the regions 7 with reinforced strength that neighbour one another in the longitudinal direction of the energy chain 1 on the other side thereof.

The two circular disc-shaped parts 12 and 13 are connected to one another by a shaft (not represented in FIGS. 1 to 8), on which they are arranged in a rotationally fixed manner via a hub 14.

As follows from FIGS. 1, 2 and 4 of the first embodiment example and FIGS. 5, 6 and 8 of the second embodiment example, the geometry of the spaces between the regions 7 with reinforced strength that neighbour one another in the longitudinal direction of the energy chain 1 corresponds to the geometry of the protrusions 11 arranged on the circular disc-shaped parts 12 and 13. In particular, in the case of chain links 2 aligned extended, the spaces have a trapezoidal geometry with a width increasing towards the drive roller 10 with respect to the longitudinal direction of the energy chain 1. Corresponding to this, the radial protrusions 11 are likewise formed trapezoidal with a width decreasing radially outwardly with respect to the longitudinal direction of the energy chain 1.

As furthermore follows from FIGS. 1 to 4 and 5 to 8 in relation to the two embodiment examples, the two circular disc-shaped parts 12 and 13 with the protrusions 11 each have, on their outwardly facing end faces, an annular flange 15, which overhangs the lateral parts 3 of the chain links 2 on the outer face in question when the protrusions 11 engage between the regions 7 that neighbour one another in the longitudinal direction of the energy chain.

The lower crosspieces 5 that are arranged at the bottom in the chain links 2 in the view of FIGS. 1 to 4 and 5 to 8 of the two embodiment examples are formed as usual cross bars and can be fastened to the lateral parts 3 lying opposite one another in the transverse direction by conventional fastening means or are moulded in one piece on the lateral parts 3. The fastening means between the lower crosspieces 5 and the lateral parts 3 correspond to the fastening means between the correspondingly shorter conventional cross bars 6 and the regions 7 with reinforced strength of the upper crosspieces 4.

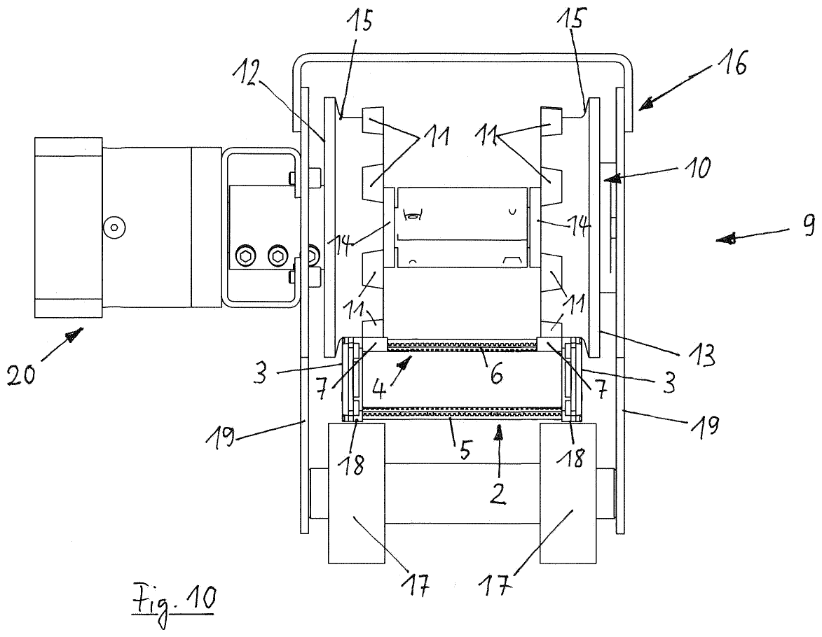

As follows from FIGS. 9 and 10, the drive roller 10 is rotatably mounted in a housing 16 of the drive unit 9, wherein arranged on the side of the energy chain 1 lying opposite the drive roller 10 are two rollers 17 that are rotatably mounted on the housing 16 and cause the chain links 2 of the energy chain 1 cooperating with the drive roller 10 to rest against the drive roller 10 and to be held in engagement with it. The lateral parts 3 of the chain links 2 lying opposite one another in the transverse direction are rollably guided on the rollers 17. For this, the lateral parts 3 have narrow sides 18 extending perpendicular to their lateral surfaces and in the longitudinal direction of the energy chain 1 which, together with the narrow sides 18 of lateral parts 3 that neighbour one another in the longitudinal direction of the energy chain 1. form a largely continuous rolling surface for the rollers 17. As follows from FIG. 9, the two rollers 17 are mounted with a little play in the direction of the axis of rotation of the drive roller 10.

The housing 16 of the drive unit 9 has two legs 19 arranged laterally outside the energy chain 1, between which the drive roller 10 and the rollers 17 are rotatably mounted.

A gear mechanism 20 operatively connected to the drive roller 10 in drive terms is arranged on one side of the housing 16.

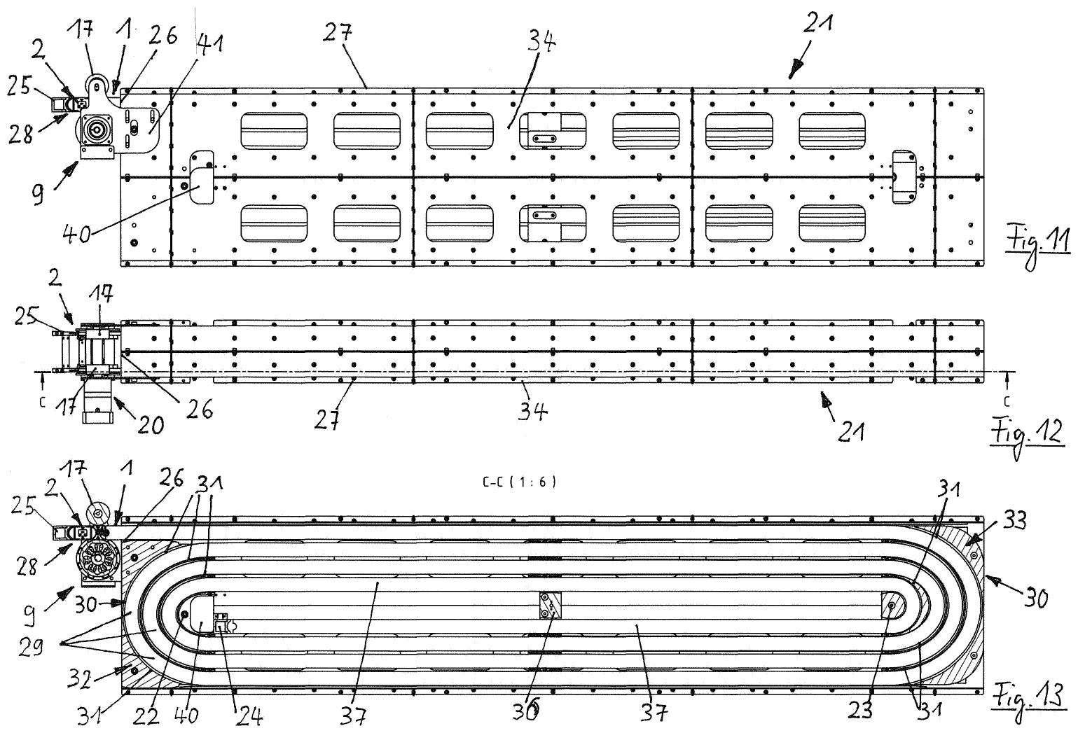

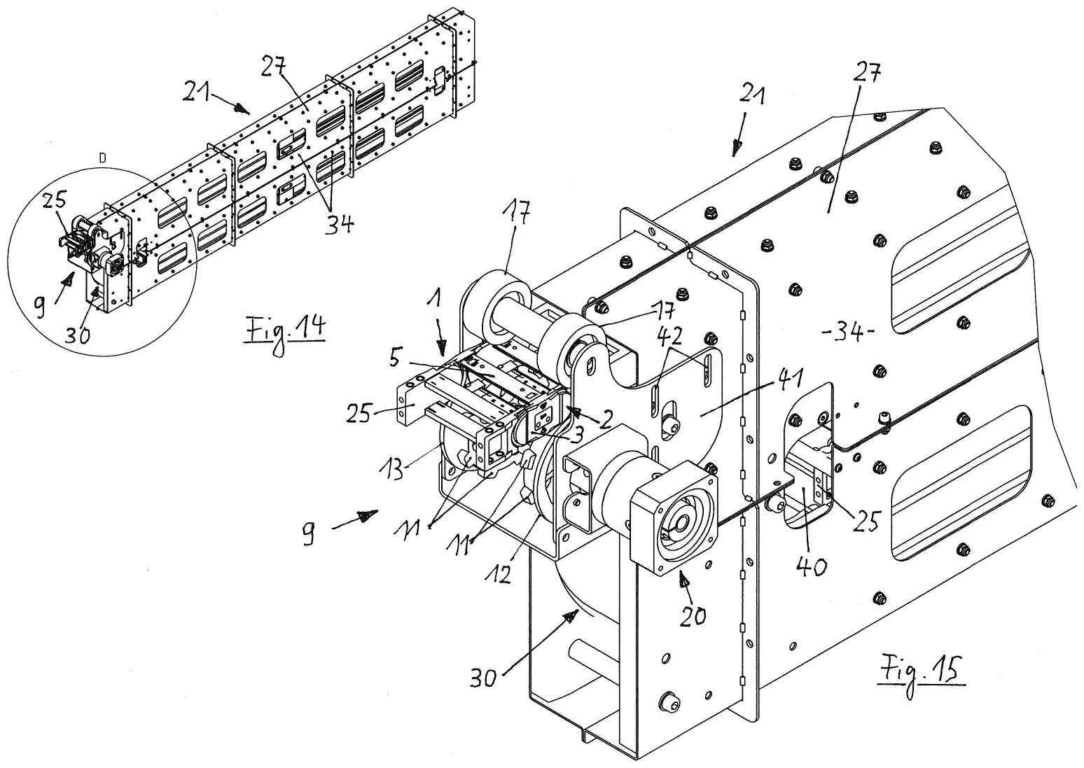

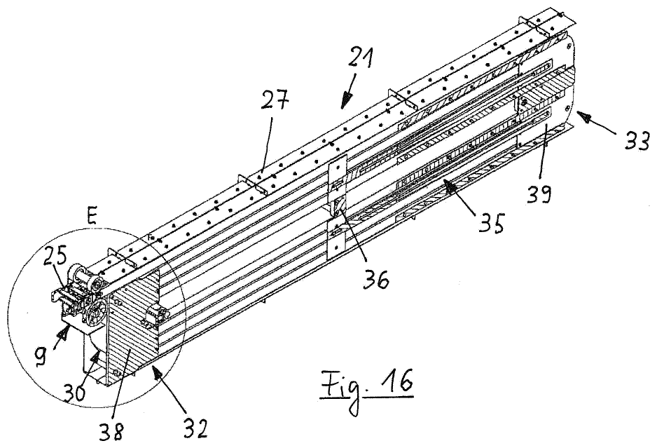

An embodiment example of a system which consists of an energy chain 1 and a drive unit 9 as described above and of a storage unit 21 for the energy chain 1 is represented in FIGS. 11-17. For the purpose of storing the energy chain 1 in the storage unit 21 it is provided that at least one portion of the energy chain 1 can be wound up in the storage unit 21 in the form of a spiral. As represented in FIG. 13, the spiral-shaped winding has two winding shafts 22 and 23 arranged at a distance from one another, wherein the fixed connector region 24 of the energy chain 1 is arranged stationary inside the winding of the energy chain 1 at the winding shaft 22. The movable connector region 25 of the energy chain 1 is arranged on a run 28 of the energy chain 1 extending through an opening 26 of the storage housing 27 of the storage unit 21. The drive unit 9 cooperates with the run 28 extending out of the storage housing 27 through the opening 26 below the energy chain 1.

FIGS. 11 to 17 show a state of the energy chain 1 in which it is retracted into the storage housing 27 to the maximum extent. Here, the distance between the winding shafts 22 and 23 is likewise at the maximum.

Whereas the winding shaft 22 represented on the left in FIG. 13 is arranged stationary in the storage housing 27, the winding shaft 23 represented on the right in FIG. 13 can move towards the stationary winding shaft 22 when the energy chain 1 is extended out of the opening 26 in the storage housing 27, until a minimum distance between the winding shafts 22 and 23 is reached based on the design. The minimum distance between the two winding shafts 22 and 23 is reached when the deflection regions 29 extending around the winding shafts 22 and 23 in a semicircular manner almost adjoin one another. In this state, the energy chain 1 is extended out of the storage unit 21 with a maximum length.

If the energy chain 1 is retracted through the opening 26 into the storage housing 27 for the purpose of storing it in the storage unit 21, the deflection regions 29 of the energy chain 1 lying opposite one another, and thus the two winding shafts 22 and 23, are removed from one another again by the pressure exerted on the run 28 by the drive unit 9 until the state represented in FIG. 13, with the maximum distance between the winding shafts 22 and 23, is reached.

No device which brings about a change in the distance between the two winding shafts 22 and 23 and contributes to the winding up and/or unwinding of the energy chain 1 in a force-exerting manner is provided between them. According to the embodiment example, the change in the distance between the winding shafts 22 and 23 is effected exclusively by the driving force acting on the run 28 running outside the storage unit 21.

As furthermore follows from FIG. 13, to guide the energy chain 1, guide elements 30 are provided in its deflection regions 29 around the winding shafts 22 and 23, with which guide elements the energy chain 1 can be guided in a sliding manner in its deflection regions 29 and follows the respective change in the distance between the two winding shafts 22 and 23. The guide elements 30 are formed as semicircular channels 31 arranged concentrically around the winding shafts 22 and 23, in which the deflection regions 29 of the energy chain 1 are guided in a sliding manner and which are arranged in link-like component parts 31 and 32.

The link-like component part 33 receiving the channels 31 extending in a semicircular manner around the winding shaft 23 is arranged movable along the line connecting the winding shafts 32 and 33 in order to enable the change in distance between the winding shafts 22 and 23.

The link-like component parts 32 and 33 are arranged between side walls 34 of the storage housing 27 arranged parallel to the deflection regions 29, wherein the link-like component part 33 is displaceably guided in a sliding manner by a guide device 35 arranged on the inside of the side walls 34.

On the inside of the side walls 34, guide means 36 are furthermore provided for supporting and guiding the inner opposite runs 37 of the spiral-shaped winding of the energy chain 1 which extend between the deflection regions 29.

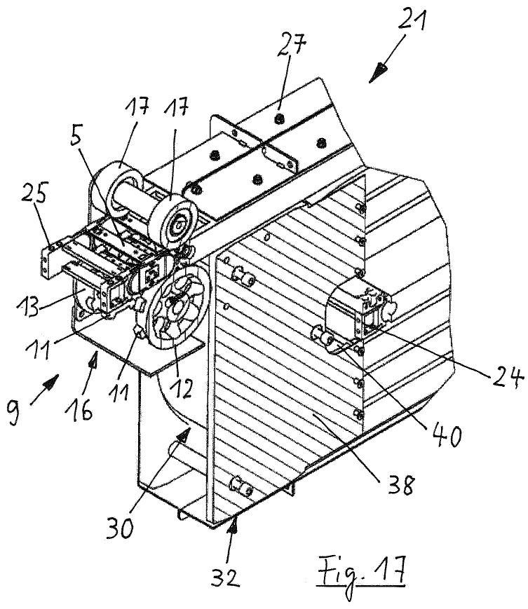

As the storage housing 27 with removed front side wall 34 shown in FIG. 16 reveals, the channels 31 (not represented there) of the link-like component parts 32 and 33 are arranged between side plates 38 and 39. Like the side wall 34 of the storage housing 27 removed in FIGS. 16 and 17, the side plate 38 belonging to the stationary link-like component part 32 has an opening 40 through which the lines guided through the energy chain 1 from the fixed connector region 24 can emerge from the storage housing 27. Furthermore, the guide device 35 for the movable link-like component part 33, on the side plate 39 of which protrusions which engage in grooves in the storage housing 27 are arranged, follows from FIGS. 16 and 17.

The housing 16 shown in FIGS. 9 and 10 and containing the drive roller 10, the chain links 2 cooperating with the drive roller 10 and the rollers 17 can be fastened to the storage housing 27, with the tab-like legs 41 shown in FIG. 9 and extending in the longitudinal direction of the energy chain 1, in the region of its opening 26, as is shown in FIGS. 11, 14 and 15. As follows in particular from FIG. 15, the legs 41 have elongated holes 42 extending in the vertical direction for screw fastenings to the storage housing 27. By virtue of the elongated holes 42, the drive unit 9 can be adjusted in the vertical direction relative to the storage housing 27.

### LIST OF REFERENCE NUMBERS

1 energy chain
2 chain link
3 lateral part
4 upper crosspiece
5 lower crosspiece
6 cross bar
7 region
8 screw
9 drive unit
10 drive roller
11 protrusion
12 circular disc-shaped part
13 circular disc-shaped part
14 hub
15 flange
16 housing
17 roller
18 narrow side
19 leg
20 gear mechanism
21 storage unit
22 winding shaft
23 winding shaft
24 fixed connector region
25 movable connector region
26 opening
27 storage housing
28 run
29 deflection region
30 guide element
31 channel
32 link-like component part
33 link-like component part
34 side wall
35 guide device
36 guide means
37 run
38 side plate
39 side plate
40 opening
41 leg
42 elongated hole
What is claimed is:

1-24. (canceled)

25. An energy chain, for receiving and guiding power and information transmission lines between a fixed connector region and a movable connector region, with a drive unit, wherein the energy chain has chain links that adjoin one another in their longitudinal direction, are pivotable relative to one another and each comprise two lateral parts that lie opposite one another in a direction transverse to the longitudinal direction and crosspieces connecting them to one another, wherein the drive unit has a drivable drive roller, which has radial protrusions that are distributed at equal distances over its circumferential region and engage between the crosspieces, wherein the crosspieces have, in their connecting regions adjacent to the lateral parts of the chain links, regions in which their strength is reinforced compared with the portions of the crosspieces lying between these regions, and the drive roller of the drive unit is arranged and formed relative to the energy chain such that the radial protrusions engage between the regions with reinforced strength of the crosspieces.

26. The energy chain and drive unit according to claim 25, wherein the regions with reinforced strength have a material reinforcement compared with the portions of the crosspieces lying in between.

27. The energy chain and drive unit according to claim 26, wherein the regions with reinforced strength have a greater width with respect to the longitudinal direction of the energy chain and/or a greater height with respect to the direction perpendicular to the longitudinal direction and running parallel to the lateral parts compared with the portions of the crosspieces lying in between.

28. The energy chain and drive unit according to claim 24, wherein the geometry of the spaces between the regions with reinforced strength, which are arranged neighbouring one another in the longitudinal direction of the energy chain in the case of adjoining chain links, corresponds to the geometry of the protrusions arranged on the drive roller.

29. The energy chain and drive unit according to claim 28, wherein the spaces are formed trapezoidal with a width increasing towards the drive roller with respect to the longitudinal direction of the energy chain.

30. The energy chain and drive unit according to claim 25, wherein the portions of the crosspieces extending between the regions with reinforced strength are formed as separate, bar-like parts, which can be connected or are connected to the adjacent regions with reinforced strength.

31. The energy chain and drive unit according to claim 30, wherein the bar-like parts can be or are detachably connected to the regions with reinforced strength.

32. The energy chain and drive unit according to claim 25, wherein the regions with reinforced strength are directly adjacent to the lateral parts neighbouring them.

33. The energy chain and drive unit according to claim 32, wherein the regions with reinforced strength are moulded in one piece on the lateral parts neighbouring them.

34. The energy chain and drive unit according to claim 32, wherein the regions with reinforced strength can be or are detachably connected to the lateral parts neighbouring them by fastening means.

35. The energy chain and drive unit according to claim 25, wherein the drive roller of the drive unit has two circular disc-shaped parts that are arranged on its end faces, are connected to one another in a rotationally fixed manner and each have the radial protrusions, wherein the protrusions of one circular disc-shaped part cooperate with the regions with reinforced strength that neighbour one another in the longitudinal direction of the energy chain on one side thereof, while the radial protrusions of the other circular disc-shaped part cooperate with the regions with reinforced strength that neighbour one another in the longitudinal direction of the energy chain on the other side thereof.

36. The energy chain and drive unit according to claim 25, wherein the drive roller has, on at least one of its outwardly facing end faces, an annular flange extending radially beyond the protrusions and overhanging the lateral parts of the chain links, which cooperate with the drive roller, on the side in question.

37. The energy chain and drive unit according to claim 25, wherein the drive unit has, on the side of the energy chain lying opposite the drive roller, at least one rotatably mounted roller, which rests against the chain links cooperating with the drive roller and holds them in engagement with the drive roller.

38. The energy chain and drive unit according to claim 37, wherein two rollers lying opposite one another in the transverse direction are provided, on which the laterally opposite lateral parts of the chain links can roll.

39. The energy chain and drive unit according to claim 37, wherein the drive roller is rotatably mounted on or in a housing of the drive unit, wherein one or both rollers are arranged rotatably mounted on or in the housing on the side of the energy chain lying opposite the drive roller.

40. The energy chain and drive unit according to claim 39, wherein a gear mechanism operatively connected to the drive roller in drive terms is arranged on one side of the housing.

41. A system, consisting of an energy chain and a drive unit according to claim 25, and of a storage unit for the energy chain, wherein at least one portion of the energy chain can be wound up in the storage unit in the form of a spiral, wherein the fixed connector region of the energy chain is arranged stationary inside the spiral-shaped winding and the movable connector region is arranged on a run of the energy chain extending through an opening of the storage unit, wherein the drive unit cooperates with the run extending out of the storage unit through the opening.

42. The system according to claim 41, wherein the spiral-shaped winding has two winding shafts arranged at a distance from one another, wherein the spiral-shaped winding consists of deflection regions and runs of the energy chain connecting them to one another.

43. The system according to claim 42, wherein no device which brings about a change in the distance between the two winding shafts and contributes to the winding up and/or unwinding of the energy chain in a force-exerting manner is provided between them.

44. The system according to claim 42, wherein the storage unit has a storage housing, wherein the storage housing and/or the deflection regions of the energy chain have guide elements that are movable relative to one another around the winding shafts parallel to the line connecting the two winding shafts, with or on which guide elements the deflection regions of the energy chain can be guided in a sliding manner during the retraction and winding up as well as during the extension and unwinding and which in the process follow the respective change in the distance between the two winding shafts.

45. The system according to claim 44, wherein the guide elements are formed as semicircular channels arranged concentrically around the winding shafts, in which the deflection regions of the energy chain are guided in a sliding manner and which are arranged in link-like component parts, wherein at least one of these component parts is arranged movable parallel to the line connecting the winding shafts.

46. The system according to claim 44, wherein the guide elements are formed as parts, in particular curved bars, which are arranged floating within the deflection regions of the energy chain and stabilize the deflection regions radially inwardly as well as outwardly.

47. The system according to claim 44, wherein the storage housing has lateral regions, which are parallel to the deflection regions and have guide means for supporting and guiding the runs of the energy chain lying directly opposite one another inside the spiral-shaped winding and extending between the deflection regions.

48. The system according to claim 44, wherein the housing of the drive unit is fastened to the storage housing, in particular with tab-shaped regions of the legs extending in the longitudinal direction of the energy chain, in the region of the opening of the drive unit.
